(19) United States
(12) Patent Application Publication
(10) Pub. No.: US 2011/0057996 A1
(43) Pub. Date: Mar. 10, 2011

(54) Printer Cartridge Having A Parasitic Power Circuit

(75) Inventor: Bruce Hammond, Castro Valley, CA (US)

(73) Assignee: MVM TECHNOLOGIES, INC., San Clemente, CA (US)

(21) Appl. No.: 12/864,583

(22) PCT Filed: Jan. 27, 2009
(86) PCT No.: PCT/US09/32089

§ 371 Date: Sep. 9, 2010

(30) Foreign Application Priority Data
Jan. 31, 2008 (US) 12023201

(51) Int. Cl. B41J 2/175

(52) U.S. Cl. 347/86

(57) ABSTRACT

Non-OEM printer cartridges for printers expecting an OEM cartridge are presented. A non-OEM printer cartridge includes a medium delivery system other than a medium delivery system ordinarily used or expected by a printer. A circuit within the non-OEM cartridge parasitically draws power from signal lines activated by the printer and powers the non-OEM cartridge's medium delivery system. Additionally, the circuit maintains a power draw and impedance within the printer's tolerance so that the printer accommodates the non-OEM cartridge.

This application claims priority to pending U.S. application Ser. No. 12/023,201 filed Jan. 30, 2008. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is printer cartridge technologies.

### BACKGROUND

Printer manufactures (e.g. HP™, Dell™, Lexmark™, Xerox™, etc. . . . ) design and develop printers that require specific printer cartridges using a medium delivery system designed for the printer. Several example medium delivery systems include thermal inkjets, piezoelectric inkjets, or continuous inkjets. Printers expect their corresponding cartridges to operate according to designed electrical characteristics or behaviors of the medium delivery system. For example, manufacturers of thermal inkjet printers have been the exclusive source of new (e.g. non-remanufactured) printer cartridges for their printer models with third party manufacturers only supplying re-manufactured (e.g. re-conditioned or re-filled) used printer cartridges.

Printer manufactures continue to design or produce new models of printers that require different cartridges than used in previous printer models. When one printer model becomes obsolete in favor of a newer model, OEMs that produce printer cartridges eventually stop manufacturing the cartridges for the older printer designs in favor of cartridges for newer printer models. Frequently, consumers find themselves in a position of owning an obsolete, yet functional printer. The consumer is forced to purchase a new printer simply because they are unable to purchase older model cartridges even though their older printer is still operable.

Ideally, consumers should be able to purchase cartridges for their functional printers long after their model of printer becomes obsolete. Unfortunately, third party manufacturers do not seek to produce such cartridges for several reasons. First, the third party must duplicate or reverse engineer older models of printer cartridges to determine how the medium delivery system operates. Such an undertaking can be quite cost prohibitive. Second, a third party cartridge has to match exactly the electrical characteristics or behaviors expected by the printer. Empirically discovering all the subtle interactions between the printer and cartridges is time consuming. Third, there could be substantial intellectual property barriers surrounding the medium delivery system to prevent the third party from producing reversed engineered cartridges. Therefore, third party manufactures avoid producing such printer cartridges.

Co-owned U.S. patent application 2006/0250667 (to Loyer et al.) addresses various aspects of creating a printer cartridge having a medium delivery system other than a medium delivery system expected by a printer. However, the application does not address how to adapt a non-OEM cartridge's electrical characteristics (e.g. impedance or power draw) or behaviors to match those expected by a printer.

What has yet to be appreciated is that non-OEM printer cartridges targeting various models of printers can be produced using alternative medium delivery systems while avoiding the issues stated above. An alternative medium delivery system will have different electrical characteristics or behaviors than those expected by the printer. However, a circuit can be included in the non-OEM cartridge that adapts the non-OEM cartridge's electrical characteristics or behaviors to match those expected by the printer. For example, the circuit can parasitically draw power from signal lines activated by the printer and use the power to operate the alternative medium delivery system while maintaining a proper load impedance or power draw on the active signal lines.

Thus, there is still a need for a non-OEM printer cartridge having an alternative medium delivery system other than a medium delivery system expected by a printer and where the printer accommodates the non-OEM cartridge when printing.

### SUMMARY OF THE INVENTION

The present invention provides apparatus, systems and methods in which a non-OEM printer cartridge will be accommodated by a printer expecting an OEM cartridge.

One aspect of the inventive subject matter includes non-OEM printer cartridges having a medium delivery system other than a medium delivery system expected by the printer. Non-OEM cartridges preferably have a plurality of signal lines that are activated by the printer from which power is drawn to power the non-OEM cartridge's medium delivery system. A circuit within the non-OEM cartridge parasitically draws power from active signal lines while ensuring the printer observes expected impedances or expected power draws that are within the printer's tolerances.

Some embodiments of a non-OEM cartridge include an independent power source. The power source, preferably a battery, powers a circuit within the cartridge when there is insufficient power supplied by the printer via the active signal lines. The power source preferably supplies power only for a time period consistent with normal printing operations. One should note the power source is not required to power the cartridge when the printer is turned off or not printing.

Within the context of this document, “non-OEM printer cartridge” means a cartridge produced by a manufacture using a design other than the recommended design of the printer manufacturer.

The term “medium” means a material that can be deposited by a printer. Printable materials preferably comprise liquid inks or other pigmented substances. However, materials are also contemplated to include other substances beyond liquids. For example, mediums can also comprise solids including powders, plastics, or other material that can be deposited on a surface.

Various objects, features, aspects and advantages of the inventive subject matter will become more apparent from the following detailed description of preferred embodiments, along with the accompanying drawings in which like numerals represent like components.

### BRIEF DESCRIPTION OF THE DRAWING

FIG. 1 is a schematic of a printer cartridge.

FIG. 2 is a schematic of a printer cartridge's internal components.

FIG. 3 is a schematic of a circuit that parasitically draws power from signal lines activated by a printer.

### DETAILED DESCRIPTION

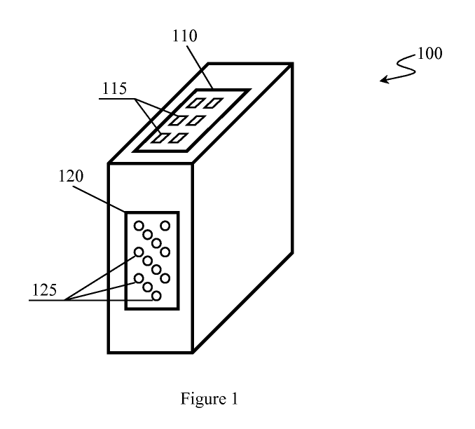

In FIG. 1 non-OEM printer cartridge 100 comprises contact pad 110 and print head 120 where non-OEM cartridge 100 is configured to replace an OEM cartridge. Although illustrated using a simple form, preferably cartridge 100 is sized and dimensioned to have substantially similar physical characteristics of the OEM cartridge it is designed to replace. Especially preferred versions of cartridge 100 ensure contact pad 110 and print head 120 are sized and dimensioned to correspond to those of the OEM cartridge to ensure a printer accommodates cartridge 100.

One should note there are a substantial variety of cartridge models, each having different physical characteristics, all of which are contemplated. Physical characteristics can vary widely from manufacturer to manufacturer as well as within a manufacturer's own product line. For example, cartridges for the HP 842C printer model are physically different than the cartridges for the HP C5180c all-in-one printer model.

Contact pad 110 includes one or more of contacts 115 that are accessible by a printer (not shown). Pad 110 and contacts 115 are sized and dimensioned to substantially match the contacts found on the OEM cartridge and in the printer. Contacts 115 couple to the printer's cartridge interface and provide the printer access to the cartridge's signal lines including, address lines, power select lines, pen selects, grounds, communication channels, or other electrical connections used to communicate with cartridge 100. A printer activates one or more of the signal lines via contacts 115. At least some of contacts 115 preferably correspond to signal lines within cartridge 100.

Print head 120 varies from embodiment to embodiment depending on which medium delivery system is employed by cartridge 100. Preferably head 120 includes a plurality of nozzles 125 used to expel a medium from cartridge 100 onto a surface. Preferred nozzles are configured with an arrangement to print with a resolution of at least 600 dpi (dots per inch) and even more preferred embodiments have nozzle arrangements to provide printing at a resolution of at least 1200 dpi.

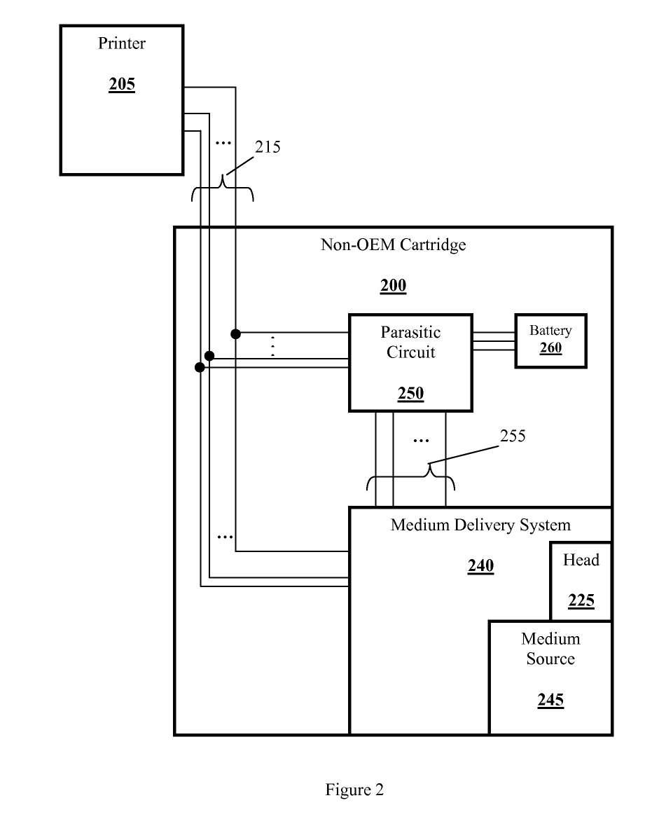

In FIG. 2 non-OEM printer cartridge 200 is adapted to operate with printer 205. Non-OEM printer cartridge comprises parasitic circuit 250, medium delivery system 240 other than a medium delivery system expected by the printer, and optional battery 260. By providing cartridge 200 having parasitic circuit 250, printer 205 accommodates cartridge 200 as having an acceptable medium delivery system.

Ordinarily printer 205 activates one or more signal lines on an OEM printer cartridge to print a medium on a surface. For example, a printer that uses a thermal inkjet technology

During operation, printer 205 using an OEM cartridge monitors (e.g. through the signal lines) one or more electrical characteristics or behaviors of the OEM cartridge to ensure the cartridge is operating as expected. Electrical characteristics include power draw (e.g. current or voltage drop), impedance, capacitance, or other electrical properties. Behaviors include timing responses, return signals or information, protocol exchanges, or other operations. Some electrical characteristics and behaviors can be found in existing literature, while others are determined empirically. Example literature containing information relating to thermal inkjet technologies includes, U.S. Pat. No. 5,644,342 (to Argyres, 1995) that describes the addressing of heating resistors, U.S. Pat. No. 5,757,394 (to Gibson et al, 1995) that describes a print head circuit that identifies the specific print head, and U.S. Pat. No. 6,431,677 (to Anderson et al, 2000) that describes methods of driving a print head.

In a preferred embodiment, non-OEM cartridge 200 includes medium delivery system 240 that could have substantially different electrical properties or behaviors than those expected by printer 205. For example, medium delivery system 240 preferably includes a piezoelectric element as a replacement for a thermoelectric element of a thermal inkjet system. A piezoelectric inkjet system utilizes a vibration element (e.g. a crystal) that flexes under a voltage difference to expel ink as opposed to using a heating element to boil the ink. A piezoelectric medium delivery system requires a different nozzle voltage to expel ink than required by a thermal inkjet delivery system. Piezoelectric delivery systems are also described elsewhere including U.S. Pat. No. 4,245,225 (to Fillmore et al, 1978) describing the use of a piezoelectric element to drive ink delivery, U.S. Pat. No. 5,757,396 (to Bruner, 1994) describing the use of ultrasonic vibrations caused by a piezoelectric actuator, and U.S. Pat. No. 6,701,593 (to Lin et al, 2001) describing production methods for piezoelectric print heads.

Cartridge 200 utilizes parasitic circuit 250 for several purposes. First, parasitic circuit 250 draws power from a signal line activated by printer 205 to power medium delivery system 240. Second, parasitic circuit 250 adjusts the electrical characteristics or behaviors of medium delivery system 240 to substantially match the properties of an OEM cartridge. Although circuit 250 is shown as separated from delivery system 240, one should note that circuit 250 can be easily incorporated into any suitable delivery system without departing from the scope of the inventive subject matter.

During operation, printer 205 could expect the electrical characteristics of signal lines 215 to vary over a large spectrum of values. Parasitic circuit 250 adaptively alters the electrical characteristics of signal lines 215 to meet the printer's expectations by responding to activity on signal lines 215.

Printer 205 expects a load impedance on different signal lines 215 to vary over many orders of magnitude. For printers designed to use thermal inkjet technologies, signal line load impedances can range from a few Ohms to many kOhms or greater from one line to another. Parasitic circuit 250 adjusts the impedance on signal lines 215 to maintain the load impedance within the printer's impedance tolerances while the signal line is active. A preferred parasitic circuit maintains the signal line's load impedance within 40% of the load impedance expected by the printer. A more preferred circuit maintains the signal line's load impedance within 20% of the expected load impedance. A yet more preferred circuit maintains the signal line's load impedance within 5% of the expected load impedance.

Additionally, printer 205 expects the power draw on signal lines 215 to be within tolerances. Just as with impedance, printers that use thermal inkjet technology expect the cartridge to have varying power requirements during use. Within the scope of this document power draw is used euphemistically to describe the voltage on the line or drawn current as well as both combined (e.g. P=IV). Thermal inkjet printers provide 24 volts on a power select line, where newer printers provide 12 volts, and yet newer printers provide 3 volts. In a preferred embodiment, non-OEM cartridge 200 accommodates signals up to 4 volts on an active signal line, where more preferred embodiments accommodate up to 13 volts, and yet more preferred embodiments accommodate up to 25 volts without damaging the non-OEM cartridge or its components.

Typically, thermal inkjet printers have different expectations for address lines and for power select lines. For example, a specific printer model expects address lines to have a load impedance in the range from approximately 20 kOhms to approximately 50 kOhms when an address line is active with a voltage of approximately 12 to 23 volts, with a corresponding current draw of about 600 μA. Alternatively, the power select lines are expected to have a load impedance in the range from approximately 8 Ohms to approximately 84 Ohms when the power select line is active with a voltage of about 12 volts, with a corresponding current draw of about 140 mA to 330 mA. One should note the previous values are from a specific model of printer and can vary substantially from one medium delivery system technology to another and can also vary from manufacturer to another or even from one printer model to another.

Because medium delivery system 240 has different electrical requirements than an OEM delivery system, one of the responsibilities of circuit 250 is to convert current drawn from one or more of signal lines 215 into current acceptable to system 240. In a preferred embodiment, circuit 250 is configured to supply system 240 an average current over a time period greater than the active time of the signal lines. In some embodiments, this is achieved through storing charge in a capacitor or an inductor as described below. In other embodiments, an independent power source can be included in cartridge 200 to supply additional power when signal lines 215 supply insufficient power. For example, optional battery 260 can be included to supply additional power needs.

Consider, for example, an embodiment where the printer expects an OEM cartridge using a thermal inkjet technology and where non-OEM cartridge 200 includes a medium delivery system 240 comprising a piezoelectric delivery system, or other system having a non-thermoelectric element. Signal lines 215 comprise at least one address line to select a heating element and at least one power select line to drive the heating element. Parasitic circuit 250 draws the bulk of its power from the power select line when it is activated by the printer. Circuit 250 drives the piezoelectric delivery system having a piezoelectric element as well as stores additional power, possibly in an inductor or capacitor. When the power select line becomes inactive, circuit 250 can continue to supply power (e.g. current or voltage) from its stored power. The power is then used to drive the piezoelectric delivery system through one or more of power lines 255 even when the power select line is not active. Especially preferred embodiments draw power from a signal line selected from at least five address lines or at least seven power select lines depending on the OEM cartridge that is being replaced.

As printer 205 interacts with cartridge 200 through signal lines 215, it also expects cartridge 200 to accommodate signal timing under the control of the printer. For example, thermal inkjet printers provide signals on address lines for up to several μS and provide signals on power select lines from a few tens of nS to several μS. During such times, circuit 250 ensures that cartridge 200 does not generate unexpected signals on signal lines 215. One should note that the timing behavior of signal lines 215 can also depend on printer make or model.

Additionally, printer 205 expects cartridge 200 to be responsive to communications over signal lines 215. Preferred signal lines 215 communicate data (e.g. control information, ID information, status or other information) between the printer and cartridge 200 using a serial communication protocol. However, it is also contemplated that signal lines 215 could also transport data using a parallel communication protocol.

Preferably at least some of signal lines 215 are passed through to medium delivery system 240. System 240 interprets the signals to determine how to operate print head 225. It is also contemplated that circuit 250 could intercept some or all of signal lines 215 and supply delivery system 240 with necessary signals to control print head 225.

In a preferred embodiment, print head 225 comprises a piezoelectric print head where the signal lines are used to address the nozzles of the print head. Print head 225 draws the medium from medium source 245, preferably a liquid ink reservoir. Although medium source 245 is preferably within cartridge 200, it is also contemplated that medium source 245 can include an external source relative to the cartridge.

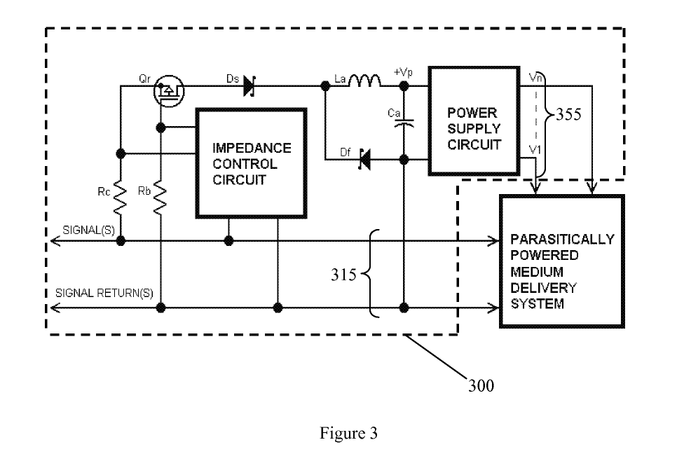

In FIG. 3 parasitic circuit 300 draws power from one or more of signal lines 315 and supplies power to a medium delivery system via one or more of power lines 355. One skilled in the art will appreciate that parasitic circuit 300 represents one embodiment of many possible circuit embodiments that can be used to maintain electrical characteristics or behaviors within a printer's tolerances. Circuit 300 and other suitable circuits are described in co-owned U.S. pending patent application Ser. No. 11/246,728, titled “Diode Power Array”.

In some embodiments, a printer may require a more constant load impedance on signal lines 315. Circuit 300 accommodates such signal lines by having resistor Rc and MOSFET Qr in series with rectification diode Ds and inductor La. It is understood that an optional impedance control circuit can be added for each signal line in use.

On initial power-up, bias resistor Rb allows the MOSFET Qr to conduct current when a signal line goes to the high state. Once storage capacitor Ca has sufficient voltage to enable the power supply circuit and the medium delivery system, the impedance control circuit will begin to operate.

Inductor La or Capacitor Ca store power while at least one of signal line 315 is active for use when the signal line is not active. Through suitable selection of the elements of circuit 300, circuit 300 is then configured to supply an average current to the medium delivery system over a time period greater than an active period of the active signal line.

It is also contemplated that parasitic circuit 300 can optionally include a microprocessor (not shown) and memory (e.g. RAM, ROM, flash, or other data storage; not shown) that stores data or instructions for use by the microprocessor. When a signal line is active, the microprocessor monitors or communicates with the printer through signal lines 315 according to the printer's expected cartridge communication protocol. The microprocessor could then adjust the electrical characteristics or behaviors observed by the printer to ensure the printer does not reject the non-OEM cartridge. For example, a Digital Signal Processor (DSP) can be used as a signal converter that converts signals from the printer to signals that can drive the medium delivery system, or that converts return signals from the medium delivery system (e.g. ID information) into signals that would be accommodated by the printer.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A non-OEM printer cartridge for use in a printer designed to print a medium on a surface using a first medium delivery system, comprising:
a plurality of signal lines that can be activated by the printer;
a second medium delivery system different than the first medium delivery system; and
a circuit configured to parasitically draw power from an active signal line selected from the plurality of signal lines and configured to maintain (a) a power draw that is within the printer's power draw tolerance, and (b) an impedance that is within the printer's impedance tolerance on the active signal line to allow accommodation of the cartridge by the printer as the second medium delivery system.

2. The printer cartridge of claim 1, wherein the plurality of signal lines comprises at least one of an address line and a power select line.

3. The printer cartridge of claim 2, wherein the plurality of signal lines comprises at least five address lines.

4. The printer cartridge of claim 2, wherein the plurality of signal lines comprises at least seven power select lines.

5. The printer cartridge of claim 1, wherein the circuit is configured to accommodate at least 13 volts on the active signal line when activated by the printer.

6. The printer cartridge of claim 4, wherein the circuit is configured to accommodate at least 25 volts on the active signal line when activated by the printer.

7. The printer cartridge of claim 1, wherein the impedance is within 40% of a load impedance expected by the printer.

8. The printer cartridge of claim 7, wherein the impedance is within 20% of the load impedance expected by the printer.

9. The printer cartridge of claim 8, wherein the impedance is within 5% of the load impedance expected by the printer.

10. The printer cartridge of claim 1, wherein the circuit supplies power to the second medium delivery system.

11. The printer cartridge of claim 10, wherein the circuit supplies power to the second medium delivery system when the active signal line becomes inactive.

12. The printer cartridge of claim 11, wherein the circuit further comprises at least one of the following: a capacitor, and an inductor.

13. The printer cartridge of claim 11, wherein the circuit is configured to supply an average current to the second medium delivery system over a time period greater than an active period of the active signal line.

14. The printer cartridge of claim 1, further comprising an independent power source that supplies power to the circuit when the active signal line provides insufficient power.

15. The printer cartridge of claim 14, wherein the independent power source comprises a battery.

16. The printer cartridge of claim 1, wherein the circuit is configured to be adaptive to a printer's expected power draw and an expected load impedance.

17. The printer cartridge of claim 1, wherein the medium comprises a liquid ink.

18. The printer cartridge of claim 1, wherein the second medium delivery system comprises a non-thermoelectric element used to delivery the medium.

19. The printer cartridge of claim 18, wherein the non-thermoelectric element comprises a piezoelectric element used to deliver the medium.
